(19) United States
(12) Patent Application Publication
(10) Pub. No.: US 2014/0290484 A1
(43) Pub. Date: Oct. 2, 2014

(54) System and Method For Treating A Saline Feed Stream To An Electro-Chlorination Unit

(71) Applicant: CAMERON SOLUTIONS, INC., Houston, TX (US)

(72) Inventors: Robert Charles William Weston, Maidenhead (GB); Gary Howard Mellor, Reading (GB); Brent R. Knox-Holmes, East Farndon (GB)

(73) Assignee: Cameron Solutions, Inc., Houston, TX (US)

(21) Appl. No.: 13/851,659

(22) Filed: Mar. 27, 2013

(51) Int. Cl. C02F 1/44

(52) U.S. Cl. CPC C02F 1/442
USPC 95/259; 210/500.21; 210/323.1; 210/651

(57) ABSTRACT

A system to reduce scaling within or downstream of an electrolytic cell includes sulfate removal membranes located upstream of one or more electrolytic cells which are arranged to receive a permeate feed stream from the sulfate removal membranes. The membranes can be nanofiltration membranes. The saline feed stream, permeate feed stream, or both may be de-aerated streams. The electrolytic cells may be part of an electro-chlorination unit and can be divided electrolytic cells.

### BACKGROUND OF THE INVENTION

This invention relates generally to systems, apparatuses and methods used to treat a saline feed source (e.g. seawater). More specifically, the invention relates to systems and methods used to treat a saline feed source to an electrolytic cell.

Precipitation and subsequent scaling occurs within or downstream of electrolytic cells which are used to produce chlorine or chlorine-produced oxidants from saline water and, in particular, from seawater. The scaling negatively affects the performance of the cells and downstream processing equipment.

The cause of the precipitation is a rise in pH at the cathode of the electrolytic cell as a result of the electrolytic process. This is a common problem where untreated seawater passes over a cathode.

### SUMMARY OF THE INVENTION

A system and method made according to this invention reduces scaling within, or downstream of an electrolytic cell used to produce chlorine or chlorine-produced oxidants from saline water and, in particular, seawater. The equipment using the treated water may include an electrolytic cell for the in-situ production of hypochlorite ions from seawater, or hydroxyl radicals from fresh water with a high scaling tendency.

### BRIEF DESCRIPTION OF THE DRAWINGS

FIG. 1A is a process diagram of a preferred embodiment of optional pre-treatment steps of a system and method made according to this invention. A saline feed stream (e.g. seawater) may be passed through an ultrafiltration or dual media filtration system or a deaerator (or both) prior to the stream being routed to the membrane system of FIG. 1B.

FIG. 1B is a process diagram of a preferred embodiment a system and method made according to this invention. A saline feed stream is pre-treated using a nanofiltration or sulfate removal membrane system and the permeate feed stream is then routed to a piece of downstream equipment housing one or more electrolytic cells, such as having an electro-chlorination unit (“ECU”).

### ELEMENTS AND ELEMENT NUMBERING USED IN THE DRAWINGS

10 Saline feed stream

13 Deaerator

17 Ultrafiltration or dual media filtration system

20 Sulfate removal membrane system or array

25 Permeate feed stream exiting 20

30 Electrolytic cell

### DETAILED DESCRIPTION OF THE PREFERRED EMBODIMENTS

A system and method made according to this invention addresses the precipitation of relatively insoluble calcium and magnesium salts from saline water and, in particular, from seawater.

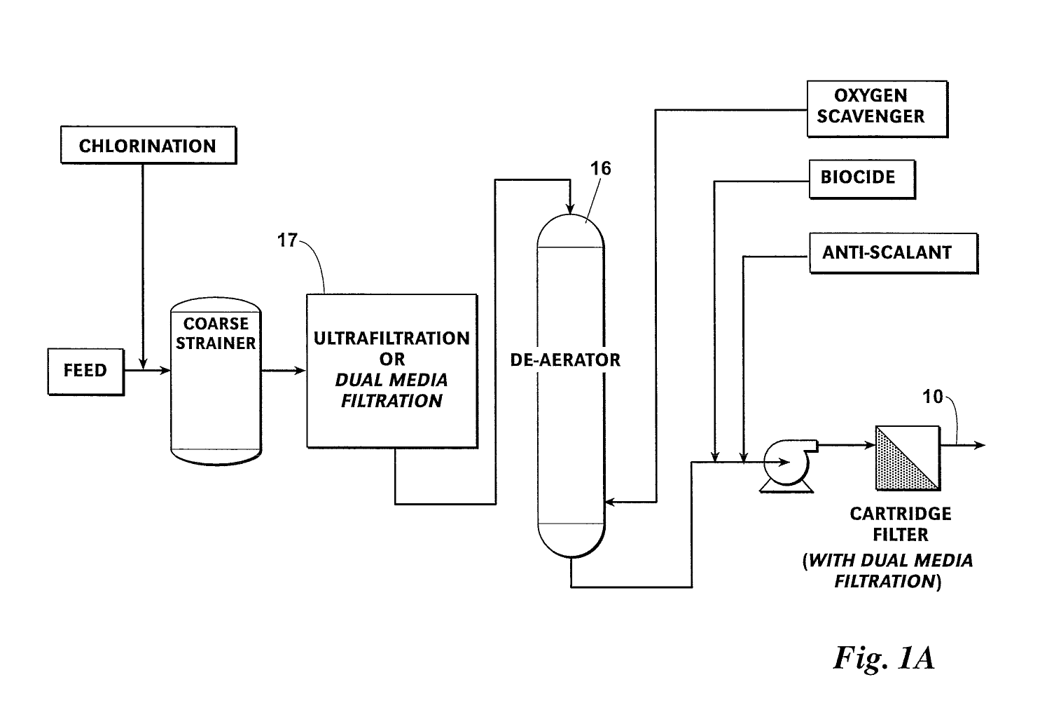

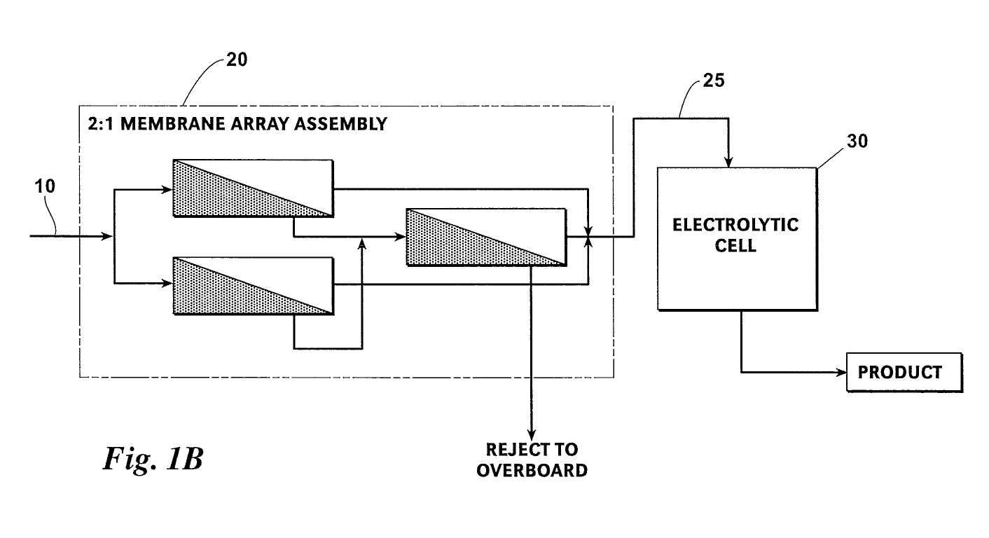

Referring to FIG. 1B, the system and method include the steps of pre-treating a saline feed stream 10 with a nanofiltration system employing sulfate removal membrane elements or a sulfate removal membrane system 20. A NATCO® sulfate removal system (Cameron Process Systems, Houston, Tex.) is a suitable nanofiltration or sulfate removal membrane system 20.

The softened low sulfate seawater (permeate stream) 25 produced in the nanofiltration or sulfate removal membrane system 20 is then routed to equipment such as an ECU housing one or more electrolytic cells 30. Optionally, the permeate stream 25 from the membrane system 20 may be de-aerated before being routed to the cells 30.

The electrolytic cell 30 may or may not be divided (with a membrane between the anode and cathode). Divided cells are not presently used with raw seawater due to the issue of membrane fouling, but can be viable if the scaling tendency has been reduced.

Examples of an electrolytic cell well suited for use in this invention is a SEACELL® electrolytic cell made (Cameron Process Systems, Houston, Tex.). This particular cell is used on a Cameron Process Systems (Houston, Tex.) electrochlorinator producing only chlorine and on a BFCC™ copper plus chlorine electrochlorinator (Cameron Process Systems).

Referring to FIG. 1A, the saline feed stream 10 may optionally have been pre-treated by using one or more pre-treatment steps prior to it being routed to the membrane system 20. For example, the stream 10 may be routed to a deaerator 13 and de-aerated prior to it being routed to the membrane system 20. Additionally, the saline feed stream 10 can be passed through an ultrafiltration or dual media filtration system 17 prior to being routed to the membrane system 20.

The preferred embodiments described above are examples of a system and method made according to this invention and are not all possible embodiments of it. The invention is limited by the scope of the following claims, including elements which are equivalent to those listed in the claims.

What is claimed:

1. A system to reduce scaling within or downstream of an electrolytic cell, the system comprising one or more sulfate removal membranes located upstream of one or more electrolytic cells and arranged to receive a saline feed stream from the one or more sulfate removal membranes.

2. A system according to claim 1 wherein a permeate stream exiting the one or more sulfate removal membranes is directly routed to the one or more electrolytic cells.

3. A system according to claim 1 wherein at least one of the sulfate removal membranes is a nanofiltration membrane.

4. A system according to claim 1 wherein at least two sulfate removal membranes are arranged in parallel.

5. A system according to claim 1 wherein the saline feed stream is a de-aerated saline feed stream.

6. A system according to claim 1 wherein the permeate stream to the one or more electrolytic cells is de-areated prior to being routed to the one or more electrolytic cells.

7. A system according to claim 1 wherein the one or more electrolytic cells are arranged as part of an electro-chlorination unit.

8. A system according to claim 1 wherein at least one of the electrolytic cells is a divided electrolytic cell.

9. A method of reducing scaling within or downstream of an electrolytic cell, the method comprising the step of routing a saline feed stream to at least one sulfate removal membrane,
wherein the sulfate removal membrane is located upstream of at least one electrolytic cell, the electrolytic cell being arranged to receive a permeate feed stream exiting the sulfate removal membrane.

10. A method according to claim 9 wherin the sulfate removal membrane is a nanofiltration sulfate removal membrane.

11. A method according to claims 9 further comprising the step of de-aerating the saline feed stream prior to routing the saline feed stream to the sulfate removal membrane.

12. A method according to claim 9 further comprising the step of de-aerating the permeate feed stream prior to routing the permeate feed stream to the electrolytic cell.
